(19) United States
(12) Patent Application Publication
(10) Pub. No.: US 2016/0246698 A1
(43) Pub. Date: Aug. 25, 2016

(54) CHANGE BASED TESTING OF A JAVASCRIPT SOFTWARE APPLICATION

(71) Applicant: HCL Technologies Limited, Noida (IN)

(72) Inventors: Yogesh Gupta, Noida (IN); Anjoli Garg, Noida (IN)

(21) Appl. No.: 15/007,088

(22) Filed: Jan. 26, 2016

(30) Foreign Application Priority Data
Feb. 21, 2015 (IN) 496/DEL/2015

(51) Int. Cl. G06F 11/36

(52) U.S. Cl. CPC G06F 11/368; G06F 11/3676

(57) ABSTRACT

System(s) and method(s) for change based testing of JavaScript software applications are disclosed. Reference and current versions of the JavaScript software application are analyzed to identify first and second sets of JavaScript programmed components. Further, a reference set of test cases configured to test the first set of intermediate representations are accepted. Then, the first and second sets of components are transformed into first and second sets of intermediate representations and compared to identify a third set of intermediate representations that is modified when the JavaScript software application is transformed from the reference to the current version. Then, a set of impacted test cases are identified from the reference set of test cases based upon the third set of intermediate representations and change based testing is performed on the current version of the JavaScript software application based on the set of impacted test cases.

### CROSS-REFERENCE TO RELATED APPLICATIONS

The present application claims benefit under 35 U.S.C. §119(a) to Indian Complete Patent Application No. 496/DEL/2015, filed on Feb. 21, 2015, the entirety of which is hereby incorporated by reference.

### TECHNICAL FIELD

The present disclosure in general relates to the field of software testing. More particularly, the present invention relates to a system and method for testing a JavaScript code present in a software application.

### BACKGROUND

Now-a-days, Information Technology (IT) Organizations are developing new strategies for developing software applications in less time. Rapid Time-to-market to new features, development of complex and larger software applications and change in software project execution model like Spiral and Agile development models has resulted in short release cycles. Many IT organizations are now adopting spiral software development strategy in order to develop software's in less time and deliver the software application to their clients each time with an updated version. The clients may suggest modifications in the present version of the software application under development and accordingly these changes are incorporated in the software application in the next development cycle to generate the updated version. However, due to quality requirements, the software application needs to undergo software testing every time before the new version of the software application is released.

With the new software development techniques and recently developed libraries, software testing has become one of the most crucial phases in JavaScript code development and has gained popularity in the past few years. JavaScript is not only object-oriented, but also lightweight and interpreted programming language. It is difficult to find a system that can test JavaScript code automatically. Approaches that are generally used for testing JavaScript code are based on manual testing of JavaScript code or generating test case using automated testing tools and then perform manual testing using the developed test cases.

The above approaches for testing JavaScript code are tedious, costly, time taking and one time exercises with no re-usability. Moreover, generating new test suites for change in code is an added overhead in the testing cycle which can affect timelines. There is a need of automated solution which is fast, cost effective and can generate and execute test cases without manual intervention for emerging JavaScript code and support outright testing in the spiral development process.

### SUMMARY

This summary is provided to introduce aspects related to systems and methods for change based testing of a JavaScript software application and the aspects are further described below in the detailed description. This summary is not intended to identify essential features of the claimed subject matter nor is it intended for use in determining or limiting the scope of the claimed subject matter.

In one embodiment, a system for change based testing of a JavaScript software application is illustrated. The system comprises a memory and a processor coupled to the memory, wherein the processor identifies a first set of components present in a reference version of the JavaScript software application, wherein the first set of components are developed using JavaScript programming language. Further, the processor transforms the first set of components into a first set of intermediate representations. Once the first set of intermediate representations are generated, the processor accepts a reference set of test cases, wherein the reference set of test cases are configured to test the first set of intermediate representations. Further, the processor identifies a second set of components present in a current version of the JavaScript software application, wherein the second set of components are developed using JavaScript programming language. Further, the processor transforms the second set of components into a second set of intermediate representations. Further the processor identifies a third set of intermediate representations from the first set of intermediate representations based upon a comparison of the first set of intermediate representations with the second set of intermediate representations, wherein the third set of intermediate representations is modified when the JavaScript software application is transformed from the reference version to the current version. Further, the processor identifies a set of impacted test cases from the reference set of test cases based upon the third set of intermediate representations. Finally the processor performs change based testing on the current version of the JavaScript software application based on the set of impacted test cases.

In one embodiment, a method for change based testing of a JavaScript software application is illustrated. The method comprises identifying a first set of components present in a reference version of the JavaScript software application, wherein the first set of components are developed using JavaScript programming language. Further, the method comprises transforming the first set of components into a first set of intermediate representations. Once the first set of intermediate representations are generated, the method comprises accepting a reference set of test cases, wherein the reference set of test cases are configured to test the first set of intermediate representations. Further, method comprises identifying a second set of components present in a current version of the JavaScript software application, wherein the second set of software components are developed using JavaScript programming language. Once the second set of software components are identified, the method comprises transforming the second set of components into a second set of intermediate representations. Further the method comprises identifying a third set of intermediate representations from the first set of intermediate representations based upon a comparison of the first set of intermediate representations with the second set of intermediate representations, wherein the third set of intermediate representations is modified when the JavaScript software application is transformed from the reference version to the current version. In the next step, the method comprises identifying a set of impacted test cases from the reference set of test cases based upon the third set of intermediate representations. The method further comprises performing change based testing on the current version of the JavaScript software application based on the set of impacted test cases.

In one embodiment, a computer program product having embodied computer program for change based testing of a JavaScript software application is disclosed. The program comprises a program code for identifying a first set of components present in a reference version of the JavaScript software application, wherein the first set of components are developed using JavaScript programming language. The program further comprises a program code for transforming the first set of components into a first set of intermediate representations. The program further comprises a program code for accepting a reference set of test cases, wherein the reference set of test cases are configured to test the first set of intermediate representations. The program further comprises a program code for identifying a second set of components present in a current version of the JavaScript software application, wherein the second set of software components are developed using JavaScript programming language. The program further comprises a program code for transforming the second set of components into a second set of intermediate representations. The program further comprises a program code for identifying a third set of intermediate representations from the first set of intermediate representations based upon a comparison of the first set of intermediate representations with the second set of intermediate representations, wherein the third set of intermediate representations is modified when the JavaScript software application is transformed from the reference version to the current version. The program further comprises a program code for identifying a set of impacted test cases from the reference set of test cases based upon the third set of intermediate representations. The program further comprises a program code for performing a change based testing on the current version of the JavaScript software application based on the set of impacted test cases.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for change based testing of a JavaScript software application, in accordance with an embodiment of the present subject matter.

FIG. 2 illustrates the system for change based testing of a JavaScript software application, in accordance with an embodiment of the present subject matter.

FIG. 3 illustrates a block diagram for processing a reference version of the JavaScript software application, in accordance with an embodiment of the present subject matter.

FIG. 4 illustrates a block diagram for processing a current version of the JavaScript software application, in accordance with an embodiment of the present subject matter,

FIG. 5 illustrates a flowchart to enable the system for change based testing of the JavaScript software application, in accordance with an embodiment of the present subject matter.

### DETAILED DESCRIPTION

The present subject matter relates to a system for change based testing of a JavaScript software application. The JavaScript software application comprises a set of software components coded using different programming languages such as ASP.Net, VB,Net, JavaScript and other programming languages. Initially, a reference version and a current version of the JavaScript software application are analyzed to identify a first set of components and a second set of components respectively, wherein the first set of components and the second set of components are components from the reference version and the current version that are developed using JavaScript programming language only. Further, a reference set of test cases are accepted by the system, wherein the reference set of test cases are configured to test the first set of intermediate representations. In the next step, the first set of components and the second set of components are transformed into a first set of intermediate representations and a second set of intermediate representations. In the next step, the first set of intermediate representations and the second set of intermediate representations are matched to identify a third set of intermediate representations from the first set of intermediate representations, wherein the third set of intermediate representations is modified when the JavaScript software application is transformed from the reference version to the current version. In the next step, a set of impacted test cases are identified from the reference set of test cases based upon the third set of intermediate representations. Further change based testing is performed on the current version of the JavaScript software application based on the set of impacted test cases.

While aspects of described system and method for change based testing of the JavaScript software application may be implemented in any number of different computing systems, environments, and/or configurations, the embodiments are described in the context of the following exemplary system.

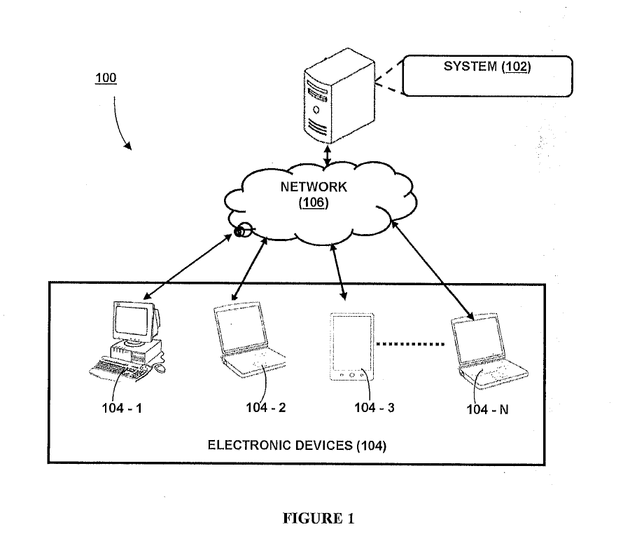

Referring now to FIG. 1, a network implementation 100 of a system 102to perform change based testing of a JavaScript software application is disclosed, wherein the JavaScript software application is developed using spiral model development process. Although the present subject matter is explained considering that the system 102 is implemented on a server, it may be understood that the system 102 may also be implemented in a variety of computing systems, such as a laptop computer, a desktop computer, a notebook, a workstation, a mainframe computer, a server, a network server, and the like. In one implementation, the system 102 may be implemented in a cloud-based environment. It will be understood that the system 102 may be accessed by multiple users through one or more user devices 104-1, 104-2 . . . 104-N, collectively referred to as user devices 104 hereinafter, or applications residing on the user devices 104. Examples of the user devices 104 may include, but are not limited to, a portable computer, a personal digital assistant, a handheld device, and a workstation. The user devices 104 are communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

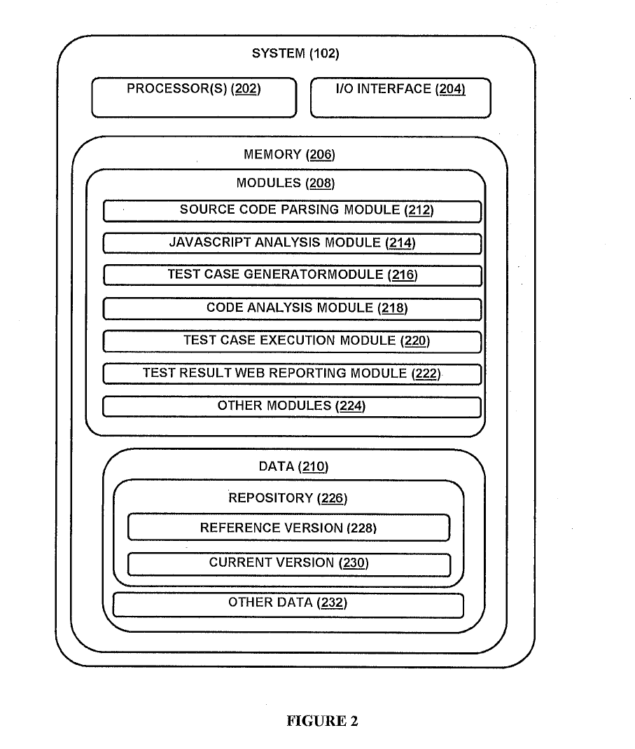

Referring now to FIG. 2, the system 102 is illustrated in accordance with an embodiment of the present subject matter. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with a user directly or through the client devices 104. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 include routines, programs, objects, components, data structures, etc., which perform particular tasks, functions or implement particular abstract data types. In one implementation, the modules 208 may include a source code parsing module 312, a JavaScript analysis module 314, a test case generator module 316, acode analysis module218, a test case execution module 220, test result web reporting module 222, and other modules 224. The other modules 224 may include programs or coded instructions that supplement applications and functions of the system 102.

The data 210, amongst other things, serves as a repository for storing data processed, received, and generated by one or more of the modules 208. The data 210 may also include a repository 226, and other data 232. In one embodiment, the repository 226 may be configured to store a reference version 228 and a current version 230 associated with the JavaScript software application. The reference version 228 is a version of the JavaScript software application that has been already tested, whereas, the current version 230is a latest software version of the JavaScript software application which is yet to be tested. In one embodiment, the reference version 228 may be a software version selected from the collection of software versions of the JavaScript software application that is already tested, whereas the current version 230 is a software version that is to be tested using the test cases applicable to the reference version 228. The system 102 uses difference between software code associated with the reference version228 and the current version 230 for identifying a set of impacted test cases which are further used for conducting change based testing of the current version 230 associated with the JavaScript software application.

In one embodiment, the other data232 may include data generated as a result of the execution of one or more modules in the other module224. In one implementation, at first, a user may use the client device 104 to access the system 102 via the I/O interface 204. The user may register using the I/O interface 204 in order to use the system 102. In one embodiment, once the user registers to the system 102, the user may send a software version as input to the system 102. The software version is stored in the system 102 as the reference version 228. Further, the system 102 is also configured to accept a reference set of test case, wherein the reference set of test cases are configured to test the JavaScript modules present in the reference version 228.

Once the reference version 228 is accepted and stored in the repository 226, in the next step, the source code parsing module 212 is configured to identify a first set of components present in a reference version 228 of the JavaScript software application. In one embodiment, the first set of components from the reference version 228 are developed using JavaScript programming language. The source code parsing module 212 uses a set of JavaScript regular expressions to parse the reference version 228 and identifies the first set of components. In the next step, the JavaScript analysis module 214 analyzes the first set of components and transforms the first set of components into a first set of intermediate representations. In one embodiment, the first set of intermediate representations is represented in the form of JavaScript Document Object Model (DOM) constructs. The JavaScript DOM constructs are DOM methods used in JavaScript code with their input parameters and output details.

Once the first set of intermediate representations is generated, the test case generator module 216 is configured to generate a reference set of test cases for testing the first set of intermediate representations. Alternately, the system 102 is configured to accept the reference set of test cases from the user devices 104 for test the first set of intermediate representations. Further, the code analysis module 218 is configured to generate a mapping file, wherein the mapping file stores code coverage information associated with each test case from the reference set of test cases for each element from the first set of intermediate representations. Further, test case execution module 220 is configured to execute the reference set of test cases and accordingly identify the test result for each test case from the reference set of test cases. The test results after the execution of the reference set of test cases are published to the user using the I/O interface 204 by the test result web reporting module 222. Alternately, the test result execution module 222 is configured to transfer the test results to the user device 104 using the I/O interface 204. Based on the test results, the user may refine the software code associated with the reference version 228 and generate a current version of the JavaScript software application.

In the next step, the system 102 is configured to accept the current version of the JavaScript software application and stores the current version as the current version 230 in the repository 226. Further, the source code parsing module 212 is configured to analyze the current version 230 and identify a second set of components present in a current version 230 of the JavaScript software application. In one embodiment, the second set of software components present in the current version 230 are developed using JavaScript programming language. The source code parsing module 212 uses a set of JavaScript regular expressions to parse the current version 230 and identifies the second set of components. In the next step, the JavaScript analysis module 214 analyzes the second set of components and transforms the second set of components into a second set of intermediate representations. In one embodiment, the second set of intermediate representations is represented in the form of JavaScript DOM constructs.

Further, the code analysis module 218 is configured to identify a third set of intermediate representations from the first set of intermediate representations, by comparing the first set of intermediate representations with the second set of intermediate representations. The comparison is based on input parameters and output details associated with the JavaScript DOM constructs from the first set of intermediate representations and the second set of intermediate representations. The third set of intermediate representations is a collection of components present in the reference version 228 that are modified when the JavaScript software application is transformed from the reference version228 to the current version 230.

Further, the code analysis module 218 is configured to identify a set of impacted test cases from the reference set of test cases based upon the third set of intermediate representations. In order to identify the set of impacted test cases, the code analysis module 218 identifies test cases that are applicable to each component from the third set of intermediate representations and accordingly stores the test cases as the set of impacted test cases.

In one embodiment, if the code coverage information associated a component from the third set of intermediate representations is not present in the mapping file, this component is identified as a newly generated component and the test case generator module 216 is configured to generate a set of new test cases for this newly generated component. Further, the new set of test cases is updated in the reference set of test cases and the impacted set of test cases. Further, the code coverage information associated with newly generated component is also recorded in the mapping file.

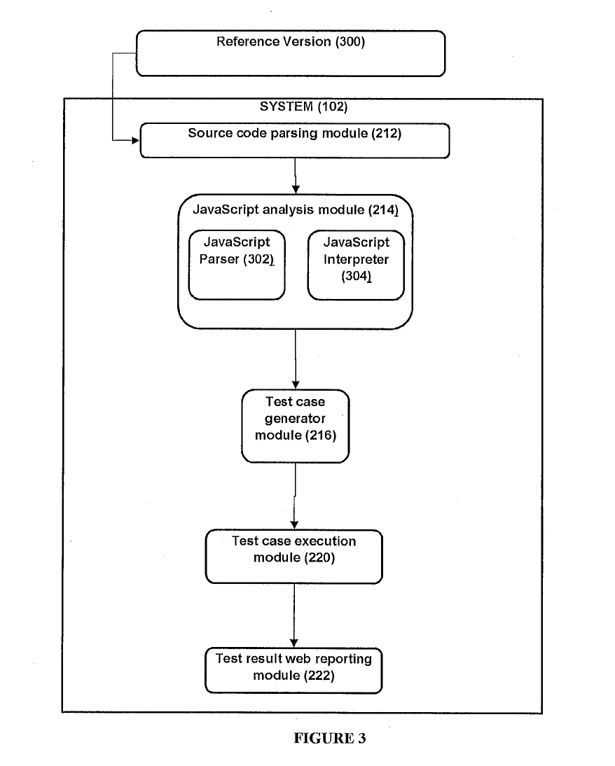

Finally the test case execution module 220 performs change based testing over the current version 230 using the set of impacted test cases and the test result web reporting module 222 reports the test results to the user using the test I/O interface 204. Alternately, the test result execution module 222 is configured to transfer the test results for the current version 230 to the user device 104 using the I/O interface 204. Based on the test results, the user may further refine the software code associated with the current version 230 and generate an updated current version of the JavaScript software application. In the next step, the current version 230 is stored by the system 102 as the reference version 228 and the updated current version is accepted and stored as the current version 230. The above software development cycle for developing and processing the current version 230 is repeated until all the test cases from the set of impacted test cases gain a pass state and there are no future updating of the JavaScript software application. In one embodiment, the JavaScript software application is developed using a spiral model development cycle, wherein the reference version228 and the current version are updated in every development cycle in the spiral model development cycle. The process for analyzing the reference version of the JavaScript software application by the system 102 for the first time is further elaborated with respect to the block diagram of FIG. 3.

FIG. 3 represent a block diagram for processing a reference version 300 of the JavaScript software application. The software code associated with the reference version 300 of the JavaScript software application is stored in the system 102 as the reference version 228. Further, the system 102 is also configured to accept a reference set of test case, wherein the reference set of test cases are configured to test the JavaScript modules present in the reference version 228.

Once the reference version 228 is accepted and stored in the repository 226, in the next step, the source code parsing module 212 is configured to identify the first set of components present in a reference version 228 of the JavaScript software application. In one embodiment, the first set of components from the reference version 228 are developed using JavaScript programming language. The source code parsing module 212 uses a set of JavaScript regular expressions to parse the reference version 228 and identifies the first set of components. In the next step, the JavaScript analysis module 214 analyzes the first set of components and transforms the first set of components into a first set of intermediate representations. For this purpose, the JavaScript analysis module 214 enabled a JavaScript Parser 302 and the JavaScript Interpreter 304. The JavaScript Parser 302 is configured to parse the first set of components and the JavaScript Interpreter 304 enables transforming the parsed first set of components into corresponding JavaScript DOM constructs which are then stored as first set of intermediate representations.

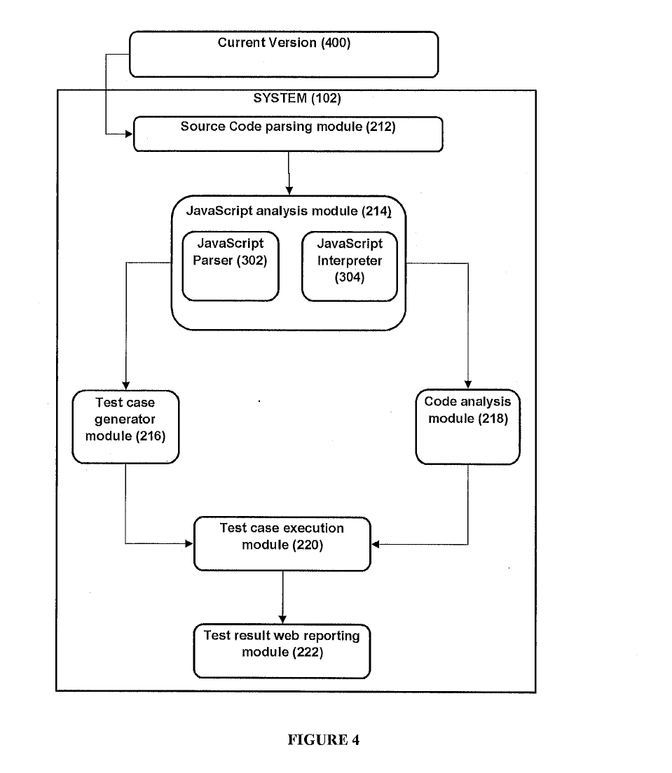

Once the first set of intermediate representations is generated, the test case generator module 216 is configured to generate a reference set of test cases. Alternately, the system 102 is configured to accept the reference set of test cases from the user devices 104 for testing the first set of intermediate representations. The reference set of test cases are a set of unit test cases and are generated by a test case generator module216 in order to test the functionality associated with the first set of intermediate representations. Further, the code analysis module 218 is configured to generate a mapping file, wherein the mapping file stores code coverage information associated with each test case from the reference set of test cases for each component from the first set of intermediate representations. Further, test case execution module 220 is configured to execute the reference set of test cases and accordingly identify the test result for each test case from the reference set of test cases. The test results after the execution of the reference set of test cases are published to the user using the I/O interface 204 by the test result web reporting module 222. Alternately, the test result execution module 222 is configured to transfer the test results to the user device 104 using the I/O interface 204. Based on the test results, the user may refine the software code associated with the reference version 228 and generate a current version of the JavaScript software application. Once the reference version 228 is processed, the system accepts the current version of the JavaScript software application as represented in FIG. 4.

FIG. 4 represents a block diagram for processing of a current version 400 of the JavaScript software application by the system 102. Initially, the system accepts the current version 400 of the JavaScript software application and stores the current version 400 as the current version 230 in the repository 226. Further, the source code parsing module 212 is configured to analyze the current version 230 and identify a second set of components present in a current version 230 of the JavaScript software application. In one embodiment, the second set of software components present in the current version 230 are developed using JavaScript programming language. The source code parsing module 212 uses a set of JavaScript regular expressions to parse the current version 230 and identifies the second set of components. In the next step, the JavaScript analysis module 214 analyzes the second set of components and transforms the second set of components into a second set of intermediate representations. In one embodiment, the second set of intermediate representations is represented in the form of JavaScript DOM constructs. For this purpose, the JavaScript analysis module 214 enabled a JavaScript Parser 302 and the JavaScript Interpreter 304. The JavaScript Parser 302 is configured to parse the second set of components and the JavaScript Interpreter 304 enables transforming the parsed second set of components into corresponding JavaScript DOM constructs which are then stored as second set of intermediate representations.

Further, the code analysis module 218 is configured to identify a third set of intermediate representations from the first set of intermediate representations, by comparing the first set of intermediate representations with the second set of intermediate representations. The third set of intermediate representations is a collection of components present in the reference version 228 that are modified when the JavaScript software application is transformed from the reference version 228 to the current version 230.

Further, the code analysis module 218 is configured to identify a set of impacted test cases from the reference set of test cases based upon the third set of intermediate representations. In order to identify the set of impacted test cases, the code analysis module 218 identifies test cases that are applicable to each component from the third set of intermediate representations and accordingly stores the test cases as the set of impacted test cases.

In one embodiment, if the code coverage information associated a component from the third set of intermediate representation is not present in the mapping file, then this component is identified as a newly generated component and the test case generator module 216 is configured to generate a set of new test cases for this newly generated component. Further, the new set of test cases is updated in the reference set of test cases and the impacted set of test cases. Further, the code coverage information associated with newly generated component is also recorded in the mapping file.

Finally the test case execution module 220 performs change based testing over the current version 230 using the set of impacted test cases and the test result web reporting module 222 reports the test results to the user using the test I/O interface 204. Alternately, the test result execution module 222 is configured to transfer the test results for the current version 230 to the user device 104 using the I/O interface 204. Based on the test results, the user may further refine the software code associated with the current version 230 and generate an updated current version of the JavaScript software application. In the next step, the current version 230 is stored by the system 102 as the reference version 228 and the updated current version is accepted and stored as the current version 230. The above cycle of processing the current version 230 is repeated until all the test cases from the set of impacted test cases gain a pass state and there are no future updating of the JavaScript software application.

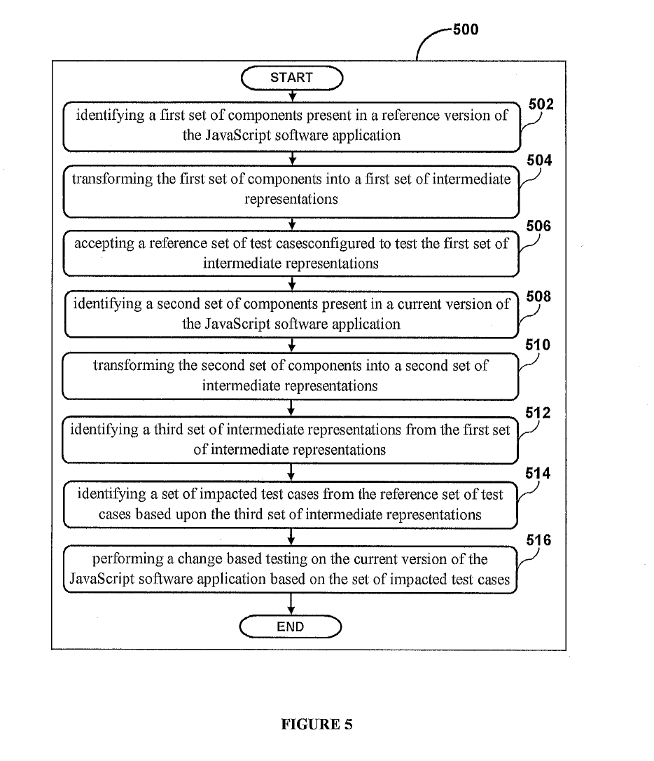

Referring now to FIG. 5, a method 500 for change based testing of the JavaScript software application, in accordance with an embodiment of the present subject matter. The method 500 may be described in the general context of computer executable instructions. Generally, computer executable instructions can include routines, programs, objects, components, data structures, procedures, modules, functions, and the like, that perform particular functions or implement particular abstract data types. The method 500 may also be practiced in a distributed computing environment where functions are performed by remote processing devices that are linked through a communications network. In a distributed computing environment, computer executable instructions may be located in both local and remote computer storage media, including memory storage devices.

The order in which the method 500 is described is not intended to be construed as a limitation, and any number of the described method blocks can be combined in any order to implement the method 500 or alternate methods. Additionally, individual blocks may be deleted from the method 500 without departing from the spirit and scope of the subject matter described herein. Furthermore, the method can be implemented in any suitable hardware, software, firmware, or combination thereof. However, for ease of explanation, in the embodiments described below, the method 500 may be considered to be implemented in the above described system 102.

At block 502, the first set of components present in the reference version228 of the JavaScript software application are identified by the source code parsing module 212, wherein the first set of components are developed using JavaScript programming language. The source code parsing module 212 uses a set of JavaScript regular expressions to parse the reference version 228 and identifies the first set of components.

At block 504, the first set of components is transformed into a first set of intermediate representations by the JavaScript analysis module 214.In one embodiment, the first set of intermediate representations is represented in the form of JavaScript Document Object Model (DOM) constructs by the JavaScript analysis module 214.

At block 506, a reference set of test cases is either accepted from the user device 104 or generated by the test case generator module 216. The reference set of test cases are configured to test the first set of intermediate representations. Further, the code analysis module 218 is configured to generate a mapping file, wherein the mapping file stores code coverage information associated with each test case from the reference set of test cases for each element from the first set of intermediate representations.

At block 508, the current version of the JavaScript software application is accepted by the source code parsing module 212 and stored as the current version 230 in the repository 226. In the next step source code parsing module 212 identifies a second set of components present in the current version 230 of the JavaScript software application, wherein the second set of software components are developed using JavaScript programming language.

At block 510, the second set of components is transformed into a second set of intermediate representations by the JavaScript analysis module 214.In one embodiment, the second set of intermediate representations is represented in the form of JavaScript Document Object Model (DOM) constructs by the JavaScript analysis module 214.

At block 510, a third set of intermediate representations is identified from the first set of intermediate representations based upon a comparison of the first set of intermediate representations with the second set of intermediate representations by the code analysis module 218, wherein the third set of intermediate representations is modified when the JavaScript software application is transformed from the reference version to the current version.

At block 512, a set of impacted test cases is identified by the code analysis module 218 from the reference set of test cases based upon the third set of intermediate representations. In order to identify the set of impacted test cases, the code analysis module 218 identifies test cases that are applicable to each component from the third set of intermediate representations and accordingly stores the test cases as the set of impacted test cases.

At block 514 change based testing is performed on the current version230 of the JavaScript software application based on the set of impacted test cases.

Although implementations for methods and systems for change based testing of the JavaScript software application have been described, it is to be understood that the appended claims are not necessarily limited to the specific features or methods described. Rather, the specific features and methods are disclosed as examples of implementations for determining optimized test suite for testing the JavaScript software application.

We claim:

1. A system for change based testing of a JavaScript software application, the system comprising:
a memory; and
a processor coupled to the memory, wherein the processor s configured to perform the steps of:
identifying a first set of components present in a reference version of the JavaScript software application, wherein the first set of components are developed using JavaScript programming language;
transforming the first set of components into a first set of intermediate representations;
accepting a reference set of test cases, wherein the reference set of test cases are configured to test the first set of intermediate representations;
identifying a second set of components present in a current version of the JavaScript software application, wherein the second set of software components are developed using JavaScript programming language;
transforming the second set of components into a second set of intermediate representations;
identifying a third set of intermediate representations from the first set of intermediate representations based upon a comparison of the first set of intermediate representations with the second set of intermediate representations, wherein the third set of intermediate representations is modified when the JavaScript software application is transformed from the reference version to the current version;
identifying a set of impacted test cases from the reference set of test cases based upon the third set of intermediate representations; and
performing a change based testing on the current version of the JavaScript software application based on the set of impacted test cases.

2. The system of claim 1, wherein the JavaScript software application is developed using a spiral model development process, wherein the current version and the reference version are updated in every development cycle in the spiral model.

3. The system of claim 1, wherein the JavaScript software application is analyzed linearly by a parser using a regular java expression to identify the first set of components and the second set of components from the reference version and the current version, respectively.

4. The system of claim 1, wherein the first set of intermediate representations, the second set of intermediate representations, and the third set of intermediate representations are represented in form of JavaScript DOM constructs.

5. The system of claim 1, wherein the third set of intermediate representations is a subset of the first set of intermediate representations that have undergone a code change in the current version.

6. The system of claim 1, wherein the reference set of test cases and the first set of intermediate representations are analyzed by a code analysis module to identify a code coverage information associated with each test case from the reference set of test cases.

7. The system of claim 6, wherein the code coverage information is used in order to identify the set of impacted test cases.

8. The system of claim 1, wherein the reference set of test cases are a set of unit test cases and are generated by a test case generator module in order to test the functionality associated with the first set of intermediate representations.

9. A method for change based testing of a JavaScript software application, the method comprising steps of:
identifying, by a processor, a first set of components present in a reference version of the JavaScript software application, wherein the first set of components are developed using JavaScript programming language;
transforming, by the processor, the first set of components into a first set of intermediate representations;
accepting, by the processor, a reference set of test cases, wherein the reference set of test cases are configured to test the first set of intermediate representations;
identifying, by the processor, a second set of components present in a current version of the JavaScript software application, wherein the second set of software components are developed using JavaScript programming language;
transforming, by the processor, the second set of components into a second set of intermediate representations;
identifying, by the processor, a third set of intermediate representations from the first set of intermediate representations based upon a comparison of the first set of intermediate representations with the second set of intermediate representations, wherein the third set of intermediate representations is modified when the JavaScript software application is transformed from the reference version to the current version;
identifying, by the processor, a set of impacted test cases from the reference set of test cases based upon the third set of intermediate representations; and
performing, by the processor, a change based testing on the current version of the JavaScript software application based on the set of impacted test cases.

10. The method of claim 9, wherein the JavaScript software application is developed using a spiral model development process, wherein the current version and the reference version are updated in every development cycle in the spiral model.

11. The method of claim 9, wherein the JavaScript software application is analyzed linearly by a parser using a regular java expression to identify the first set of components and the second set of components from the reference version and the current version, respectively.

12. The method of claim 9, wherein the first set of intermediate representations, the second set of intermediate representations, and the third set of intermediate representations are represented in form of JavaScript DOM constructs.

13. The method of claim 9, wherein the third set of intermediate representations is a subset of the first set of intermediate representations that have undergone a code change in the current version.

14. The method of claim 9, wherein the reference set of test cases and the first set of intermediate representations are analyzed by a code analysis module to identify a code coverage information associated with each test case from the reference set of test cases.

15. The method of claim 14, wherein the code coverage information is used in order to identify the set of impacted test cases.

16. The method of claim 9, wherein the reference set of test cases are a set of unit test cases and are generated by a test case generator module in order to test the functionality associated with the first set of intermediate representations.

17. A computer program product having embodied thereon a computer program for change based testing of a JavaScript software application, the computer program product comprising:
a program code for identifying a first set of components present in a reference version of the JavaScript software application, wherein the first set of components are developed using JavaScript programming language;
a program code for transforming the first set of components into a first set of intermediate representations;
a program code for accepting a reference set of test cases, wherein the reference set of test cases are configured to test the first set of intermediate representations;
a program code for identifying a second set of components present in a current version of the JavaScript software application, wherein the second set of software components are developed using JavaScript programming language;
a program code for transforming the second set of components into a second set of intermediate representations;
a program code for identifying a third set of intermediate representations from the first set of intermediate representations based upon a comparison of the first set of intermediate representations with the second set of intermediate representations, wherein the third set of intermediate representations is modified when the JavaScript software application is transformed from the reference version to the current version;
a program code for identifying a set of impacted test cases from the reference set of test cases based upon the third set of intermediate representations; and
a program code for performing a change based testing on the current version of the JavaScript software application based on the set of impacted test cases.
